(19) United States
(12) Patent Application Publication
(10) Pub. No.: US 2018/0142191 A1
(43) Pub. Date: May 24, 2018

(54) USE OF A COMBINATION OF A COMPLEXING AGENT AND A SURFACTANT FOR IMPROVING RINSE PERFORMANCE

(71) Applicant: Henkel AG & Co. KGaA, Duesseldorf (DE)

(72) Inventors: Inga Kerstin Vockenroth, Duesseldorf (DE); David Matulla, Hilden (DE); Oliver Kurth, Langenfeld (DE); Volker Blank, Leverkusen (DE)

(73) Assignee: Henkel AG & Co. KGaA, Duesseldorf (DE)

(21) Appl. No.: 15/876,700

(22) Filed: Jan. 22, 2018

Related U.S. Application Data
(63) Continuation of application No. PCT/EP2016/067267, filed on Jul. 20, 2016.

(30) Foreign Application Priority Data
Jul. 23, 2015 (DE) 102015213938.7

(51) Int. Cl. C11D 17/00; C11D 1/72; C11D 3/33; C11D 11/00

(52) U.S. Cl. CPC C11D 17/0078; C11D 1/721; C11D 3/386; C11D 11/0023; C11D 3/33

(57) ABSTRACT

A solid multiphase dishwashing detergent including at least two phases, the use of such a dishwashing detergent, and a method for cleaning dishes using such a dishwashing detergent.

### FIELD OF THE INVENTION

The present invention relates to a solid multiphase dishwashing detergent comprising at least two phases, the use of such a dishwashing detergent, and a method for cleaning dishes using such a dishwashing detergent.

### BACKGROUND OF THE INVENTION

Greater demands are frequently imposed on machine-washed dishes compared to hand-washed dishes. Thus, even a dish that is completely clean of food residues at first glance is not considered to be satisfactory if it has so-called “spotting” (drops) or “filming” (hazy film) after the machine dishwashing.

Plastics are particularly critical with regard to the rinse performance, since they usually have a nonpolar surface and a lower heat capacity compared to porcelain and glass. The runoff and drying behavior of water droplets is unsatisfactory, as the result of which visible water stains remain on the plastic surface. This effect is intensified by high levels of water hardness, and is more noticeable on colored plastic wash items (Tupperware®, for example).

Tableting of base or core tablets (formulas) having a high methylglycinediacetic acid (MGDA) content is difficult due to the fact that the raw material MGDA is not easily pressable in large quantities, resulting, for example, in significant caking during stamping and damage to the tablet surface.

It has surprisingly now been found that the so-called spotting on dishes may be reduced compared to a conventional automatic dishwashing detergent formulation by adding a combination of complexing agents and surfactant, discussed below, to an automatic dishwashing detergent, as the result of which the dishes (in particular plastic) are cleaner, and in particular for the consumer, have a visually clean appearance.

Instead of the customary pressed core, an MGDA-containing melt core is used in which larger quantities of MGDA and surfactant may be formulated in comparison to conventional pressed cores. Compared to a pressed core, with a melt core approximately twice the quantity of MGDA and approximately ten times the quantity of surfactant may be used. For pressed cores this is not possible, since tacky, unpressable powders would result with this quantity of surfactant and MGDA. Compared to the standard tablet having a pressed core, the disintegration time and the dissolving time of the overall tablet having a melt core is not delayed, and instead shows a comparable solubility profile.

In a first aspect, the present invention is therefore directed to a dishwashing detergent comprising at least one first solid compacted phase and at least one second phase, the at least one second phase being a melt core that includes at least one surfactant, in particular a nonionic surfactant, in a quantity of 1 to 90% by weight, preferably 10 to 40% by weight, relative to the total weight of the melt core, and at least one complexing agent from the group of aminocarboxylic acids and the salts thereof, in a quantity of 1 to 90% by weight, preferably 30 to 60% by weight, relative to the total weight of the melt core.

In another aspect, the present invention is directed to the use of a dishwashing detergent according to the invention for machine-cleaning dishes.

In a last aspect, the present invention is directed to a method for machine-cleaning dishes, wherein a dishwashing detergent according to the invention is used in at least one method step.

According to the invention, a dishwashing detergent is understood to mean any agent that is suitable for washing or cleaning hard surfaces, in particular dishes. Further suitable ingredients are described in greater detail below.

These and further aspects, features, and advantages of the invention are apparent to the person skilled in the art, based on a review of the following detailed description and the claims. Any feature from one aspect of the invention may be used in any other aspect of the invention. In addition, it is understood that examples contained herein are intended to describe and illustrate the invention, but not to limit same; in particular, the invention is not limited to these examples. Unless stated otherwise, all percentages refer to % by weight. Numerical ranges given in the format “from x to y” include the stated values. When multiple preferred numerical ranges are given in this format, it is understood that all ranges that result from the combination of the various end points are likewise included.

“At least one,” as used herein, refers to 1 or more, for example 1, 2, 3, 4, 5, 6, 7, 8, 9, or more.

### BRIEF SUMMARY OF THE INVENTION

The dishwashing detergent according to the invention comprises at least two phases, the first phase being solid and compacted, and the second phase being a melt. A “melt” refers to a composition that is liquefied under the effect of elevated temperatures (>50° C., for example), and which resolidifies and takes on a solid form upon cooling to room temperature.

Within the meaning of the present invention, a phase is a spatial region in which physical parameters and the chemical composition are homogeneous. One phase differs from another phase by virtue of different features, for example ingredients, physical properties, external appearance, etc. Various phases may preferably be visually different. Thus, the consumer may clearly distinguish the at least one first phase from the at least one second phase. If the washing or cleaning agent according to the invention has more than one first phase, these first phases in each case may likewise be distinguished from one another with the naked eye, due to having different colorings, for example. The same applies when two or more second phases are present. In this case as well, a visual distinction of the phases, for example due to a difference in color or transparency, is possible. Within the meaning of the present invention, phases are thus self-contained regions which the consumer may visually distinguish from one another with the naked eye. The individual phases may have different properties during use, for example the speed with which the phase dissolves in water, and thus, the speed and the sequence of release of the ingredients contained in the particular phase.

The dishwashing detergent according to the invention comprises at least two different phases. The at least one first phase as well as the at least one second phase are described below. For the case that the dishwashing detergent according to the invention has more than two phases, any further phase in each case corresponds to either the at least one first phase as defined herein, or to the at least one second phase as defined herein. The compositions of the mutually corresponding phases may differ to the extent allowed by the definitions stated below for the at least one first phase and the at least one second phase. Thus, for example, this may involve a three-phase dishwashing detergent having two phases that correspond to the first phase as defined herein, and one phase that corresponds to the second phase as defined herein.

According to the present invention, the at least one second phase of the dishwashing detergent is a melt core that includes at least one surfactant, in particular a nonionic surfactant, in a quantity of 1 to 90% by weight, preferably 10 to 40% by weight, relative to the total weight of the melt core, and at least one complexing agent from the group of aminocarboxylic acids and the salts thereof in a quantity of 1 to 90% by weight, preferably 30 to 60% by weight, relative to the total weight of the melt core. The second phase is therefore also referred to below as the “melt core” or “melt core phase.”

All nonionic surfactants known to the person skilled in the art may be used in this at least one melt core phase as nonionic surfactants. In preferred embodiments, however, nonionic surfactants from the group of alkoxylated alcohols are used. Accordingly, one class of preferably usable nonionic surfactants, which may be used either as a nonionic surfactant alone or in combination with other nonionic surfactants as a component of the melt core phase, are alkoxylated, preferably ethoxylated or ethoxylated and propoxylated, fatty acid alkyl esters.

Particularly preferred in this regard are nonionic surfactants that are end-capped, poly(oxyalkylated) nonionic surfactants according to the formula R¹O[CH₂CH₂O]ₓR², where R¹ stands for linear or branched, saturated or unsaturated, aliphatic or aromatic hydrocarbon functional groups having 2 to 30 carbon atoms, preferably having 4 to 22 carbon atoms, and R² stands for linear or branched, saturated or unsaturated, aliphatic or aromatic hydrocarbon functional groups having 1 to 30 carbon atoms, and where x stands for values between 1 and 80, preferably for values between 15 and 50, and in particular for values between 20 and 25. Very particularly preferred are end-capped fatty alcohol ethoxylates in which R¹ stands for a linear or branched C₁₂₋₂₀ alkyl functional group, in particular for a linear or branched C₁₆₋₁₈ alkyl functional group, and/or R² stands for a linear or branched C₄₋₂₂ alkyl functional group, preferably a C₄₋₁₄ alkyl functional group, more preferably a C₆₋₁₂ alkyl functional group, in particular a linear or branched C₈₋₁₀ alkyl functional group.

In preferred embodiments, the above-described end-capped, poly(oxyalkylated) nonionic surfactants of the melt core phase are used in quantities of 5-60% by weight, preferably 10-40% by weight, relative to the melt core phase.

In another embodiment, the above-described end-capped, poly(oxyalkylated) nonionic surfactants of the melt core phase are combined with a further surfactant from the group of non-endcapped, poly(oxyalkylated) nonionic surfactants according to the formula R¹O[CH₂R³HO]ₓH, where R¹ stands for linear or branched, saturated or unsaturated, aliphatic or aromatic hydrocarbon functional groups having 2 to 30 carbon atoms, preferably having 4 to 22 carbon atoms, each R³ independently stands for H, CH₃, or CH₂—CH₃, preferably for H or CH₃, and x stands for values between 1 and 80, preferably for values between 15 and 50, and in particular for values between 20 and 25. Very particularly preferred are fatty alcohol ethoxylates or fatty alcohol ethoxypropoxylates in which R¹ stands for a linear or branched C₁₂₋₂₀ alkyl functional group, in particular a linear or branched C₁₆₋₁₈ alkyl functional group.

In preferred embodiments, the above-described non-endcapped, poly(oxyalkylated) nonionic surfactants of the melt core phase are used in quantities of 5-50% by weight, preferably 10-30% by weight, relative to the melt core phase.

The nonionic surfactants used in the surfactant melt phase generally have a melting point above room temperature. Nonionic surfactant(s) having a melting point above 25° C., preferably between 25 and 50° C., and in particular between 26.6 and 43.3° C., is/are particularly preferred.

According to one embodiment, the complexing agent is contained in the melt core phase in a quantity of 1 to 90% by weight, preferably 30 to 60% by weight, relative to the total weight of the melt core.

The complexing agents from the group of aminocarboxylic acids and the salts thereof, contained in the at least one second phase, may be, for example, methylglycinediacetic acid (MGDA) or the salts thereof, glutaminediacetic acid (GLDA) or the salts thereof, or ethylenediamine diacetic acid (EDDS) or the salts thereof. According to one preferred embodiment, the complexing agent is methylglycinediacetic acid.

The melt core phase may contain even further ingredients in addition to the mentioned surfactants and complexing agent. Such ingredients preferably include polyethylene glycol (PEG), for example. PEG may be contained in quantities of, for example, 10 to 40% by weight, preferably 25 to 35% by weight, relative to the weight of the melt core phase. Other polymers, in particular polycarboxylates, may likewise be preferably contained in the melt core phase.

The at least one first phase of the dishwashing detergent according to the invention is a solid compacted phase, typically a pressed powder phase. This at least one first phase of the dishwashing detergent according to the invention generally contains at least one surfactant, preferably at least one nonionic surfactant. Suitable surfactants are described below.

Suited as nonionic surfactants of the first phase are, for example, alkyl glycosides of the general formula RO(G)ₓ, in which R corresponds to a primary straight-chain or methyl-branched, in particular methyl-branched in the 2-position, aliphatic functional group having 8 to 22, preferably 12 to 18 C atoms, and G is a symbol that stands for a glycose unit having 5 or 6 C atoms, preferably for glucose. The degree of oligomerization x, which indicates the distribution of monoglycosides and oligoglycosides, is any given number between 1 and 10; x is preferably 1.2 to 1.4.

Nonionic surfactants of the aminoxide type, for example N-cocoalkyl-N,N-dimethylaminoxide and N-tallow alkyl-N,N-dihydroxyethylaminoxide, and the fatty acid alkanolamides may also be suitable. The quantity of these nonionic surfactants is preferably not greater than that of the ethoxylated fatty alcohols, in particular no more than one-half thereof.

Other suitable surfactants are the polyhydroxy fatty acid amides, known as PHFA.

However, low-foaming nonionic surfactants, in particular alkoxylated, primarily ethoxylated, low-foaming nonionic surfactants are preferably used in the first phase. It is particularly advantageous for the automatic dishwashing detergents to contain nonionic surfactants from the group of alkoxylated alcohols.

Accordingly, one class of usable nonionic surfactants, which may be used as nonionic surfactant alone or in combination with other nonionic surfactants, is alkoxylated, preferably ethoxylated or ethoxylated and propoxylated, fatty acid alkyl esters preferably having 1 to 4 carbon atoms in the alkyl chain.

Preferred surfactants to be used come from the groups of the ethoxylated primary alcohols and mixtures of these surfactants with structurally complex surfactants such as polyoxypropylene/polyoxyethylene/polyoxypropylene (PO/EO/PO) surfactants. Such (PO/EO/PO) nonionic surfactants are characterized by good foam control.

Suitable nonionic surfactants are those having alternating ethylene oxide and alkylene oxide units. Among these, surfactants having EO-AO-EO-AO blocks are preferred, in each case one to ten EO or AO groups being bound to one another before being followed by a block of the respective other group. Preferred here are nonionic surfactants of the general formula

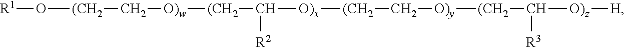

in which R¹ stands for a straight-chain or branched, saturated or singly or multiply unsaturated C₆₋₂₄ alkyl or alkenyl functional group; each group R² or R³ is independently selected from —CH₃, —CH₂CH₃, —CH₂CH₂—CH₃, CH(CH₃)₂, and the indices w, x, y, z independently stand for integers from 1 to 6. Of these, particularly preferred are nonionic surfactants having a C₉₋₁₅ alkyl functional group with 1 to 4 ethylene oxide units, followed by 1 to 4 propylene oxide units, followed by 1 to 4 ethylene oxide units, followed by 1 to 4 propylene oxide units.

Preferred nonionic surfactants are those of the general formula

R¹—CH(OH)CH₂O—(AO)_{w}—(A′O)ₓ—(A″O)_{y}—(A′″O)_{z}—R²,

in which
R¹ stands for a straight-chain or branched, saturated or singly or multiply unsaturated C₆₋₂₄ alkyl or alkenyl functional group;
R² stands for H or a linear or branched hydrocarbon functional group having 2 to 26 carbon atoms;
A, A′, A″, and A′″ independently stand for a functional group from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y, and z stand for values between 0.5 and 120, where x, y, and/or z may also be 0.

Particularly preferred are those end-capped, poly(oxyalkylated) nonionic surfactants which, according to the formula R¹O[CH₂CH₂O]ₓCH₂CH(OH)R², in addition to a functional group R¹, which stands for linear or branched, saturated or unsaturated, aliphatic or aromatic hydrocarbon functional groups having 2 to 30 carbon atoms, preferably 4 to 22 carbon atoms, also include a linear or branched, saturated or unsaturated, aliphatic or aromatic hydrocarbon functional group R² having 1 to 30 carbon atoms, where x stands for values between 1 and 90, preferably for values between 10 and 80, and in particular for values between 20 and 60. Particularly preferred are surfactants of the above formula in which R¹ stands for C₇ to C₁₃, x stands for a whole natural number from 16 to 28, and R² stands for C₈ to C₁₂.

Also preferred are surfactants of formula R¹O[CH₂—CH(CH₃)O]ₓ[CH₂CH₂O]_{y}CH₂CH(OH)R², in which R¹ stands for a linear or branched aliphatic hydrocarbon functional group having 4 to 18 carbon atoms or mixtures thereof, R² stands for a linear or branched hydrocarbon functional group having 2 to 26 carbon atoms or mixtures thereof, x stands for values between 0.5 and 1.5, and y stands for a value of at least 15.

The group of these nonionic surfactants includes, for example, the C₂₋₂₆ fatty alcohol-(PO)₁-(EO)₁₅₋₄₀-2-hydroxyalkyl ethers, in particular also the C₈₋₁₀ fatty alcohol-(PO)₁-(EO)₂₂-2-hydroxydecyl ethers. Also particularly preferred are those end-capped poly(oxyalkylated) nonionic surfactants of formula R¹O[CH₂CH₂O]ₓ[CH₂CH(R³)O]_{y}CH₂CH(OH)R², in which R¹ and R² independently stand for a linear or branched, saturated or singly or multiply unsaturated hydrocarbon functional group having 2 to 26 carbon atoms, R³ is independently selected from —CH₃, —CH₂CH₃, —CH₂CH₂—CH₃, —CH(CH₃)₂, but preferably stands for —CH₃, and x and y independently stand for values between 1 and 32, with nonionic surfactants with R³=—CH₃ and values for x of 15 to 32 and values of y of 0.5 and 1.5 being very particularly preferred.

Further nonionic surfactants that are preferably usable are the end-capped poly(oxyalkylated) nonionic surfactants of formula R¹O[CH₂CH(R³)O]ₓ[CH₂]ₖCH(OH)[CH₂]ⱼOR², in which R¹ and R² stand for linear or branched, saturated or unsaturated, aliphatic or aromatic hydrocarbon functional groups having 1 to 30 carbon atoms, R³ stands for H or a methyl, ethyl, n-propyl, isopropyl, n-butyl, 2-butyl, or 2-methyl-2-butyl functional group, x stands for values between 1 and 30, and k and j stand for values between 1 and 12, preferably between 1 and 5. When the value of x is ≥2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon functional groups having 6 to 22 carbon atoms, with functional groups having 8 to 18 C atoms being particularly preferred. H, —CH₃, or —CH₂CH₃ is particularly preferred for the functional group R³. Particularly preferred values for x are in the range of 1 to 20, in particular 6 to 15.

As described above, each R³ in the above formula may be different if x is ≥2. Thus, the alkylene oxide unit in brackets may be varied. If x stands for 3, for example, the functional group R³ may be selected in order to form ethylene oxide (R³=H) units or propylene oxide (R³=CH₃) units, which may be joined together in any sequence, for example (EO)(PO)(EO), (EO)(EO)(PO), (EO)(EO)(EO), (PO)(EO)(PO), (PO)(PO)(EO), and (PO)(PO)(PO). The value 3 for x has been selected as an example, and may in fact be larger; the range of variation increases with increasing x values, and for example includes a large number of (EO) groups combined with a small number of (PO) groups, or vice versa.

Particularly preferred end-capped poly(oxyalkylated) alcohols of the above formula have values of k=1 and j=1, so that the above formula simplifies to R¹O[CH₂CH(R³)O]ₓCH₂CH(OH)CH₂OR². In the latter-mentioned formula, R², and R³ are defined as above, and x stands for numbers from 1 to 30, preferably from 1 to 20, and in particular from 6 to 18. Surfactants in which the functional groups R¹ and R² have 9 to 14 C atoms, R³ stands for H, and x has values of 6 to 15 are particularly preferred.

Lastly, the nonionic surfactants of the general formula R¹—CH(OH)CH₂O—(AO)_{w}—R² have proven to be particularly effective in which
R¹ stands for a straight-chain or branched, saturated or singly or multiply unsaturated C₆₋₂₄ alkyl or alkenyl functional group;
R² stands for a linear or branched hydrocarbon functional group having 2 to 26 carbon atoms;
A stands for a functional group from the group CH₂CH₂, CH₂CH₂CH₂, CH₂CH(CH₃), preferably for CH₂CH₂, and
w stands for values between 1 and 120, preferably 10 to 80, in particular 15 to 50.

The group of these nonionic surfactants includes, for example, the C₄₋₂₂ fatty alcohol-(EO)₁₀₋₈₀-2-hydroxyalkyl ethers, in particular also the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

In various embodiments of the invention, instead of the end-capped hydroxy mixed ethers defined above, the corresponding non-endcapped hydroxy mixed ethers may be used. These may satisfy the above formulas, except that R² is hydrogen, and R¹, R³, A, A′, A″, A′″, w, x, y, and z are defined as above.

The stated C chain lengths and ethoxylation numbers or alkoxylation numbers of the nonionic surfactants represent statistical average values, which for a specific product may be an integer or a fractional number. Due to the production methods, commercial products of the stated formulas are usually composed of mixtures, not individual representatives, so that average values, and consequently fractional numbers, may result for the C chain lengths and also for the ethoxylation numbers or alkoxylation numbers.

Of course, the above-mentioned nonionic surfactants may be used not only as individual substances, but also as surfactant mixtures of two, three, four, or more surfactants. Surfactant mixtures refer not to mixtures of nonionic surfactants which as a whole fall under one of the general formulas mentioned above, but, rather, to those mixtures containing two, three, four, or more nonionic surfactants that may be described by different formulas of the general formulas described above.

### DETAILED DESCRIPTION OF THE INVENTION

The dishwashing detergents described herein, which in the at least one first phase include at least one surfactant, preferably a nonionic surfactant, preferably a nonionic surfactant from the group of hydroxy mixed ethers, in various embodiments contain the surfactant in a quantity of at least 2% by weight, preferably at least 5% by weight, relative to the total weight of the agent. The absolute quantities used per application may be, for example, in the range of 0.5-10 g/job, preferably in the range of 1-5 g/job.

Those nonionic surfactants having a melting point above room temperature are particularly preferred. Nonionic surfactant(s) having a melting point above 20° C., preferably above 25° C., particularly preferably between 25 and 60° C., and in particular between 26.6 and 43.3° C., is/are particularly preferred.

Suitable nonionic surfactants having melting points or softening points in the stated temperature range are, for example, low-foaming nonionic surfactants that are solid at room temperature.

In general, the first phase may also contain the surfactants described above in conjunction with the second phase, in particular the described optionally end-capped fatty alcohol ethoxylates.

The first phase of the dishwashing detergent according to the invention may also contain surfactants from the group of anionic, cationic, and amphoteric surfactants.

All anionic surface-active substances are suitable as anionic surfactants in the dishwashing detergents. These are characterized by a water-solubilizing anionic group, such as a carboxylate, sulfate, sulfonate, or phosphate group, and a lipophilic alkyl group having approximately 8 to 30 C atoms. In addition, glycol or polyglycol ether groups, ester, ether, and amide groups as well as hydroxyl groups may be contained in the molecule. Suitable anionic surfactants are preferably present in the form of the sodium, potassium, and ammonium salts, and the mono-, di-, and trialkanolammonium salts having 2 to 4 C atoms in the alkanol group; however, zinc, manganese(II), magnesium, calcium, or mixtures thereof may also be used as counterions.

Preferred anionic surfactants are alkyl sulfates, alkylpolyglycol ether sulfates, and ethercarboxylic acids having 10 to 18 C atoms in the alkyl group and up to 12 glycol ether groups in the molecule.

Cationic and/or amphoteric surfactants, such as betaines or quaternary ammonium compounds, may be used instead of or in conjunction with the mentioned surfactants. However, it is preferred that no cationic and/or amphoteric surfactants be used.

Furthermore, the dishwashing detergent may contain further ingredients in the at least one first phase which further improve the application-related and/or esthetic properties of the dishwashing detergent. Within the scope of the present invention, in various embodiments the dishwashing detergent contains at least one or preferably multiple substances from the group of builders, polymers, bleaching agents, bleach activators, bleach catalysts, enzymes, thickeners, sequestering agents, electrolytes, corrosion inhibitors, glass corrosion inhibitors, foam inhibitors, dyes, additives for improving the runoff and drying behavior, disintegration agents, preservatives, pH adjusters, fragrances, and fragrance carriers.

The use of builder substances (builders) such as silicates, aluminum silicates (in particular zeolites), salts of organic di- and polycarboxylic acids, and mixtures of these substances, preferably water-soluble builder substances, may be advantageous.

In one embodiment that is preferred according to the invention, the use of phosphates (also polyphosphates) is largely or completely dispensed with. In this embodiment, the agent preferably contains less than 5% by weight, particularly preferably less than 3% by weight, in particular less than 1% by weight, phosphate(s). In this embodiment, the agent is particularly preferably completely phosphate-free; i.e., the agents contain less than 0.1% by weight phosphate(s).

The builders include in particular carbonates, citrates, phosphonates, organic builders, and silicates. The weight fraction of total builders in the total weight of agents according to the invention is preferably 15 to 80% by weight and in particular 20 to 70% by weight.

According to the invention, suitable organic builders are, for example, polycarboxylic acids that are usable in the form of their sodium salts (polycarboxylates), polycarboxylic acids being understood to mean carboxylic acids bearing more than one, in particular two to eight, acid functions, preferably two to six, in particular two, three, four, or five acid functions in the overall molecule. Dicarboxylic acids, tricarboxylic acids, tetracarboxylic acids, and pentacarboxylic acids, in particular di-, tri-, and tetracarboxylic acids, are thus preferred as polycarboxylic acids. The polycarboxylic acids may contain additional functional groups, for example hydroxyl or amino groups. Examples include citric acid, adipic acid, succinic acid, glutaric acid, malic acid, tartaric acid, maleic acid, fumaric acid, sugar acids (preferably aldaric acids, for example galactaric acid and glucaric acid), aminocarboxylic acids, in particular aminodicarboxylic acids, aminotricarboxylic acids, aminotetracarboxylic acids such as nitrilotriacetic acid (NTA), glutamine-N,N-diacetic acid (also referred to as N,N-bis(carboxymethyl)-L-glutaminic acid or GLDA), methylglycinediacetic acid (MGDA), and the derivatives thereof and mixtures thereof. Preferred salts are the salts of the polycarboxylic acids such as citric acid, adipic acid, succinic acid, glutaric acid, tartaric acid, GLDA, MGDA, and mixtures thereof.

Also suited as organic builders are polymeric polycarboxylates (organic polymers having a plurality of (in particular greater than ten) carboxylate functions in the macromolecule), polyaspartates, polyacetals, and dextrins.

The free acids, in addition to their builder effect, typically also have the property of an acidifier component, and thus may be also used for setting a lower pH if desired. Mentioned in particular are citric acid, succinic acid, glutaric acid, adipic acid, gluconic acid, and any given mixtures thereof.

Particularly preferred cleaning agents according to the invention, in particular dishwashing detergents, preferably automatic dishwashing detergents, contain as one of their essential builders one or more salts of citric acid, i.e., citrates. These are preferably contained in a proportion of 2 to 40% by weight, in particular 5 to 30% by weight, particularly preferably 7 to 28% by weight, very particularly preferably 10 to 25% by weight, extremely preferably 15 to 20% by weight, in each case relative to the total weight of the agent.

Likewise particularly preferred is the use of carbonate(s) and/or hydrogen carbonate(s), preferably alkali carbonate(s), particularly preferably sodium carbonate (soda), in quantities of 2 to 50% by weight, preferably 4 to 40% by weight, in particular 10 to 30% by weight, very particularly preferably 10 to 24% by weight, in each case relative to the weight of the agent.

Particularly preferred cleaning agents according to the invention, in particular dishwashing detergents, preferably automatic dishwashing detergents, are wherein they contain at least two builders from the group of silicates, phosphonates, carbonates, aminocarboxylic acids, and citrates, wherein the weight fraction of these builders is preferably 5 to 70% by weight, particularly preferably 15 to 60% by weight, and in particular 20 to 50% by weight, relative to the total weight of the cleaning agent according to the invention. The combination of two or more builders from the above group has proven to be advantageous for the cleaning and rinse performance of cleaning agents according to the invention, in particular dishwashing detergents, preferably automatic dishwashing detergents. One or more other builders may also be contained in addition to the builders mentioned here.

Preferred cleaning agents, in particular dishwashing detergents, preferably automatic dishwashing detergents, are characterized by a builder combination of citrate and carbonate and/or hydrogen carbonate.

In one embodiment that is very particularly preferred according to the invention, a mixture of carbonate and citrate is used, wherein the quantity of carbonate is preferably 5 to 40% by weight, in particular 10 to 35% by weight, very particularly preferably 15 to 30% by weight, and the quantity of citrate is preferably 5 to 35% by weight, in particular 10 to 25% by weight, very particularly preferably 15 to 20% by weight, in each case relative to the total quantity of the cleaning agent, the total quantity of these two builders preferably being 20 to 65% by weight, in particular 25 to 60% by weight, preferably 30 to 50% by weight. One or more additional builders may also be contained.

The cleaning agents according to the invention, in particular dishwashing detergents, preferably automatic dishwashing detergents, may contain in particular phosphonates as a further builder. A hydroxyalkane phosphonate and/or aminoalkane phosphonate is preferably used as the phosphonate compound. Among the hydroxyalkane phosphonates, 1-hydroxyethane-1,1-diphosphonate (HEDP) is of particular importance. Preferably ethylenediamine tetramethylene phosphonate (EDTMP), diethylenetriamine pentamethylene phosphonate (DTPMP), and the higher homologs thereof are suitable as aminoalkane phosphonates. Phosphonates are preferably contained in agents according to the invention in quantities of 0.1 to 10% by weight, in particular in quantities of 0.5 to 8% by weight, very particularly preferably in quantities of 2.5 to 7.5% by weight, in each case relative to the total weight of the agent.

The combined use of citrate, (hydrogen) carbonate, and phosphonate is particularly preferred. These substances may be used in the quantities stated above. In particular, quantities of 10 to 25% by weight citrate, 10 to 30% by weight carbonate (or hydrogen carbonate), and 2.5 to 7.5% by weight phosphonate are used in this combination, in each case relative to the total weight of the agent.

Further particularly preferred cleaning agents, in particular dishwashing detergents, preferably automatic dishwashing detergents, are wherein they contain at least one further phosphorus-free builder in addition to citrate and (hydrogen) carbonate and optionally phosphonate. The further phosphorus-free builder is selected in particular from aminocarboxylic acids, preferably selected from methylglycinediacetic acid (MGDA), glutaminic acid diacetate (GLDA), aspartic acid diacetate (ASDA), hydroxyethylimino diacetate (HEIDA), imino disuccinate (IDS), and ethylenediamine disuccinate (EDDS), particularly preferably from MGDA or GLDA. An example of a particularly preferred combination is citrate, (hydrogen) carbonate, and MGDA and optionally phosphonate.

The % by weight portion of the further phosphorus-free builder, in particular MGDA and/or GLDA, is preferably 0 to 40% by weight, in particular 5 to 30% by weight, particularly preferably 7 to 25% by weight. The use of MGDA or GLDA, in particular MGDA, as a granulate is particularly preferred. MGDA granulates that preferably contain very little water and/or that have a lower hygroscopicity (water absorption at 25° C., standard pressure) compared to ungranulated powder are advantageous. The combination of at least three, in particular at least four, builders from the above group has proven to be advantageous for the cleaning and rinse performance of cleaning agents according to the invention, in particular dishwashing detergents, preferably automatic dishwashing detergents. Even further builders may also be contained.

Also suited as organic builders are polymeric polycarboxylates, for example the alkali metal salts of polyacrylic acid or polymethacrylic acid, for example those having a relative molecular mass of 500 to 70,000 g/mol. Suitable polymers are in particular polyacrylates that preferably have a molecular mass of 2000 to 20,000 g/mol. Of this group, the short-chain polyacrylates having molar masses of 2000 to 10,000 g/mol, and particularly preferably 3000 to 5000 g/mol, may be preferred due to their superior solubility.

The content of (homo)polymeric polycarboxylates in the cleaning agents according to the invention, in particular dishwashing detergents, preferably automatic dishwashing detergents, is preferably 0.5 to 20% by weight, preferably 2 to 15% by weight, and in particular 4 to 10% by weight.

Cleaning agents according to the invention, in particular dishwashing detergents, preferably automatic dishwashing detergents, may also contain crystalline phyllosilicates of the general formula NaMSiₓO₂ₓ₊₁.y H₂O as builders, where M represents sodium or hydrogen, x stands for a number from 1.9 to 22, preferably from 1.9 to 4, and particularly preferred values for x are 2, 3 or 4, and y stands for a number from 0 to 33, preferably from 0 to 20. Also usable are amorphous sodium silicates having an Na₂O:SiO₂ modulus of 1:2 to 1:3.3, preferably 1:2 to 1:2.8, and in particular 1:2 to 1:2.6, and which preferably dissolve with delay and have secondary wash properties.

In certain cleaning agents according to the invention, in particular dishwashing detergents, preferably automatic dishwashing detergents, the content of silicates is limited to quantities below 10% by weight, preferably below 5% by weight, and in particular below 2% by weight, relative to the total weight of the cleaning agent.

The washing or cleaning agents according to the invention may also contain alkali metal hydroxides in addition to the builders mentioned above. These alkali carriers are contained in the washing or cleaning agents, and in particular in the second phases, preferably only in small quantities, preferably in quantities below 10% by weight, preferably below 6% by weight, particularly preferably below 5% by weight, very particularly preferably between 0.1 and 5% by weight, and in particular between 0.5 and 5% by weight, in each case relative to the total weight of the washing or cleaning agent. Alternative cleaning agents according to the invention are free of alkali metal hydroxides.

The at least one first phase of the dishwashing detergents described herein may also contain various polymers.

According to the invention, for example homopolymers of α,β-ethylenically unsaturated carboxylic acids may be used in various embodiments. Used particularly advantageously as unsaturated carboxylic acid(s) are unsaturated carboxylic acids of formula R¹(R²)C═C(R³)COOH, in which R¹ through R³ independently stand for —H, —CH₃, a straight-chain or branched saturated alkyl functional group having 2 to 12 carbon atoms, a straight-chain or branched, singly or multiply unsaturated alkenyl functional group having 2 to 12 carbon atoms, alkyl or alkenyl functional groups as defined above, substituted with —NH₂, —OH, or —COOH, or stand for —COOH or —COOR⁴, where R⁴ is a saturated or unsaturated, straight-chain or branched hydrocarbon functional group having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid (methylmaleic acid), methylenemalonic acid, sorbic acid, cinnamic acid, or the mixtures thereof. Acrylic acid is very particularly preferred. In various embodiments of the invention, the homopolymer is therefore a polyacrylic acid.

The carboxylic acid groups may be present in the polymers completely or partially in neutralized form; i.e., the acidic hydrogen atom of the carboxylic acid group in some or all carboxylic acid groups may be substituted by metal ions, preferably alkali metal ions and in particular sodium ions. The use of partially or completely neutralized polymers is preferred according to the invention.

The molar mass of the homopolymers used may be varied in order to adapt the properties of the polymers to the desired purpose. Preferred dishwashing detergents are wherein the homopolymers, in particular the polyacrylic acids, have molar masses Mₙ of 1000 to 20,000 g/mol. Of this group, the short-chain polyacrylates having molar masses of 1000 to 10,000 g/mol, particularly preferably 1500 to 5000 g/mol, may be preferred due to their superior solubility.

In various preferred embodiments of the invention, the agents also contain at least one sulfopolymer. The polymers usable in this regard are in particular copolymers which may have two, three, four, or more different monomer units, wherein at least one monomer unit bears a sulfonic acid group.

Preferred copolymers contain, in addition to monomer(s) containing sulfonic acid groups, at least one monomer from the group of unsaturated carboxylic acids.

The above-described unsaturated carboxylic acids are particularly advantageously used as unsaturated carboxylic acid(s). Acrylic acid is very particularly preferred.

For the monomers containing sulfonic acid groups, those of formula

R⁵(R⁶)C═C(R⁷)—X—SO₃H

are preferred, in which R⁵ through R⁷ independently stand for —H, —CH₃, a straight-chain or branched saturated alkyl functional group having 2 to 12 carbon atoms, a straight-chain or branched, singly or multiply unsaturated alkenyl functional group having 2 to 12 carbon atoms, alkyl or alkenyl functional groups substituted with —NH₂, —OH, or —COOH, or stand for —COOH or —COOR⁴, where R⁴ is a saturated or unsaturated, straight-chain or branched hydrocarbon functional group having 1 to 12 carbon atoms, and X stands for an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₃)—CH₂—.

Among these monomers, those of formulas

H₂C═CH—X—SO₃H

H₂C═C(CH₃)—X—SO₃H

HO₃S—X—(R⁶)C═C(R⁷)—X—SO₃H,

in which R⁶ and R⁷ are independently selected from —H, —CH₃, —CH₂CH₃, —CH₂CH₂CH₃, and —CH(CH₃)₂, and X stands for an optionally present spacer group that is selected from —(CH₂)ₙ— where n=0 to 4, —COO—(CH₂)ₖ— where k=1 to 6, —C(O)—NH—C(CH₃)₂—, —C(O)— NH—C(CH₃)₂—CH₂—, and —C(O)—NH—CH(CH₃)—CH₂—.

Particularly preferred monomers containing sulfonic acid groups are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide, and mixtures of the stated acids or the water-soluble salts thereof.

The acid groups may also be present in the copolymers completely or partially in neutralized form; i.e., the acidic hydrogen atom of the sulfonic acid group and/or carboxylic acid group in some or all acid groups may be substituted by metal ions, preferably alkali metal ions and in particular sodium ions. The use of partially or completely neutralized copolymers is preferred according to the invention.

For copolymers that contain only monomers containing carboxylic acid groups and monomers containing sulfonic acid groups, the monomer distribution of the copolymers preferably used is preferably in each case 5 to 95% by weight, the proportion of the monomer containing sulfonic acid groups is particularly preferably 50 to 90% by weight, and the proportion of the monomer containing carboxylic acid groups is 10 to 50% by weight, the monomers preferably being selected from those mentioned above.

In various embodiments, in addition to the above-described monomers containing carboxylic acid groups and monomers containing sulfonic acid groups, the copolymers may contain further monomers, in particular monomers containing unsaturated carboxylic acid ester groups. In such terpolymers, the monomers containing carboxylic acid ester groups are, for example, those of formula R¹(R²)C═C(R³)COOR⁴, in which R¹ through R³ are defined as above and R⁴ is a saturated or unsaturated, straight-chain or branched hydrocarbon functional group having 1 to 12 carbon atoms.

Particularly preferred unsaturated carboxylic acid esters are alkyl esters of monocarboxylic acids such as acrylic acid, methacrylic acid, ethacrylic acid, α-chloroacrylic acid, α-cyanoacrylic acid, crotonic acid, α-phenylacrylic acid, sorbic acid, cinnamic acid, or the mixtures thereof. Very particularly preferred are C₁₋₈ alkyl esters of acrylic acid, such as methyl acrylate, ethyl acrylate, propyl acrylate, and butyl acrylate. Ethyl acrylate is very particularly preferred.

The molar mass of the copolymers used may be varied in order to adapt the properties of the polymers to the desired purpose. Preferred dishwashing detergents are wherein the copolymers have molar masses Mₙ of 2000 to 200,000 g/mol, preferably 4000 to 25,000 g/mol, and in particular 5000 to 15,000 g/mol.

The homopolymers and copolymers described above may be used in each case in quantities of 0.5 to 10% by weight, preferably 1 to 5% by weight, relative to the total weight of the agent used. Absolute quantities are typically in the range of 0.1 to 2 g/job, preferably in the range of 0.2 to 1.0 g/job. In various embodiments, the mass ratio of the polymers to one another, i.e., homopolymer to copolymer, is 5:1 to 1:5, preferably 2:1 to 1:2.

Alternatively or additionally, the dishwashing detergents may contain further polymers. The group of suitable polymers includes in particular the amphoteric, zwitterionic, or cationic polymers having cleaning activity, for example the rinse polymers and/or polymers that act as softeners.

Preferred usable amphoteric polymers come from the group of alkylacrylamide/acrylic acid copolymers, alkylacrylamide/methacrylic acid copolymers, alkylacrylamide/methylmethacrylic acid copolymers, alkylacrylamide/acrylic acid/alkylaminoalkyl(meth)acrylic acid copolymers, alkylacrylamide/methacrylic acid/alkylaminoalkyl(meth)acrylic acid copolymers, alkylacrylamide/methylmethacrylic acid/alkylaminoalkyl(meth)acrylic acid copolymers, alkylacrylamide/alkyl methacrylate/alkylaminoethyl methacrylate/alkyl methacrylate copolymers, and the copolymers of unsaturated carboxylic acids, cationically derivatized unsaturated carboxylic acids, and optionally further ionic or nonionogenic monomers.

Further usable zwitterionic polymers come from the group of acrylamidoalkyltrialkylammonium chloride/acrylic acid copolymers and the alkali and ammonium salts thereof, acrylamidoalkyltrialkylammonium chloride/methacrylic acid copolymers and the alkali and ammonium salts thereof, and methacroylethylbetaine/methacrylate copolymers.

Usable cationic polymeric come from the groups of quaternized cellulose derivatives, polysiloxanes having quaternary groups, cationic guar derivatives, polymeric dimethyldiallyl ammonium salts, and the copolymers thereof with acrylic acid and methacrylic acid, and the esters and amides thereof, copolymers of vinylpyrrolidone with quaternized derivatives of dialkylamino acrylates and methacrylates, vinylpyrrolidone-methoimidazolinium chloride copolymers, quaternized polyvinyl alcohols, or the polymers stated under the INCI names Polyquaternium 2, Polyquaternium 17, Polyquaternium 18, and Polyquaternium 27.

In one particularly preferred embodiment of the present invention, the above-mentioned amphoteric, zwitterionic, or cationic polymers are present in pre-prepared form. The following, among others, are suitable for providing the polymers:
encapsulation of the polymers by means of water-soluble or water-dispersible coating agents, preferably by means of water-soluble or water-dispersible natural or synthetic polymers;
encapsulation of the polymers by means of water-insoluble, meltable coating agents, preferably by means of water-insoluble coating agents from the group of waxes or paraffins having a melting point above 30° C.;
cogranulation of the polymers with inert carrier materials, preferably with carrier materials from the group of washing- or cleaning-active substances, particularly preferably from the group of builders or cobuilders.

As a further component, dishwashing detergents according to the invention preferably contain one or more enzymes in the first phase. These include in particular proteases, amylases, lipases, hemicellulases, cellulases, perhydrolases, or oxidoreductases, and preferably the mixtures thereof. These enzymes in principle are of natural origin; starting from the natural molecules, improved variants which are preferably correspondingly used are available for use in cleaning agents. Cleaning agents according to the invention preferably contain enzymes in total quantities of 1×10⁻⁶% by weight to 5% by weight, relative to active protein. The protein concentration may be determined by known methods, for example the BOA method or the biuret method.

Among the proteases, those of the subtilisin type are preferred. Examples of such are the subtilisins BPN′ and Carlsberg and their enhanced forms, the protease PB92, the subtilisins 147 and 309, the alkaline protease from Bacillus lentus, subtilisin DY, and the enzymes thermitase, proteinase K, and the proteases TW3 and TW7, which may be associated with the subtilases, but not with the subtilisines in the narrower sense.

Examples of amylases that are usable according to the invention are the α-amylases from Bacillus licheniformis, B. amyloliquefaciens, B. stearothermophilus, Aspergillus niger, and A. oryzae, as well as the enhancements of the above-mentioned amylases that are improved for use in cleaning agents. Also noteworthy for this purpose are the α-amylases from Bacillus sp. A 7-7 (DSM 12368) and cyclodextrin glucanotransferase (CGTase) from B. agaradherens (DSM 9948).

According to the invention, also usable are lipases or cutinases, in particular due to their triglyceride-splitting activity, but also in order to produce peracids in situ from suitable precursors. These include, for example, lipases originally obtainable from Humicola lanuginosa (Thermomyces lanuginosus) or enhanced lipases, in particular those with the amino acid exchange in positions D96L, T213R, and/or N233R, particularly preferably all of the exchanges D96L, T213R, and N233R.

Enzymes that are collectively referred to as hemicellulases may also be used. These include, for example, mannanases, xanthanlyases, pectin lyases (pectinases), pectinesterases, pectate lyases, xyloglucanases (xylanases), pullulanases, and β-glucanases.

According to the invention, oxidoreductases, for example oxidases, oxygenases, catalases, peroxidases such as halo-, chloro-, or bromoperoxidases, lignin peroxidases, glucose peroxidases, or manganese peroxidases, dioxygenases, or laccases (phenoloxidases, polyphenoloxidases) may be used to increase the bleaching effect. In addition, organic, particularly preferably aromatic, compounds that interact with the enzymes are advantageously added to increase the activity of the oxidoreductases in question (enhancers), or to ensure the electron flow between the oxidizing enzymes and the soiling under greatly different redox potentials (mediators). A protein and/or enzyme may be protected, particularly during storage, from damage such as inactivation, denaturation, or decomposition, for example due to physical influences, oxidation, or proteolytic cleavage. For microbial recovery of the proteins and/or enzymes, inhibition of the proteolysis is particularly preferred, in particular when the agents also contain proteases. Cleaning agents may contain stabilizers for this purpose; the provision of such agents represents a preferred embodiment of the present invention.

Proteases and amylases having cleaning activity are generally provided not in the form of the pure protein, but, rather, in the form of stabilized storable and transportable preparations. These pre-prepared preparations include, for example, the solid preparations obtained by granulation, extrusion, or lyophilization or, in particular for liquid or gel agents, solutions of the enzymes, advantageously preferably concentrated, low in water, and/or combined with stabilizers or further auxiliary agents.

Alternatively, the enzymes for the first and/or second phase may be encapsulated, for example by spray drying or extrusion of the enzyme solution together with a preferably natural polymer or in the form of capsules, for example those in which the enzymes are enclosed as in a solidified gel, or in those of the core-shell type, in which an enzyme-containing core is coated with a protective layer that is impermeable to water, air, or chemicals. Further active ingredients such as stabilizers, emulsifiers, pigments, bleaching agents, or dyes may be additionally provided in overlaid layers. Such capsules are applied according to methods known per se, for example by oscillating granulation or rolling granulation or in fluid bed processes. These types of granulates are low in dust, for example due to the application of polymeric film-forming agents, and stable in storage due to the coating.

It is also possible to provide two or more enzymes together, so that an individual granulate has multiple enzyme activities.

As is apparent from the above discussion, the enzyme protein forms only a fraction of the total weight of customary enzyme preparations. Protease and amylase preparations that are preferably used according to the invention contain between 0.1 and 40% by weight, preferably between 0.2 and 30% by weight, particularly preferably between 0.4 and 20% by weight, and in particular between 0.8 and 10% by weight, of the enzyme protein. Preferred in particular are those cleaning agents which, in each case relative to their total weight, contain 0.1 to 12% by weight, preferably 0.2 to 10% by weight, and in particular 0.5 to 8% by weight, of the particular enzyme preparations.

The dishwashing detergent may also contain one or more enzyme stabilizers. Examples of suitable enzyme stabilizers include boron-containing compounds such as boric acid or boronic acid and the salts and esters thereof, polyols such as glycerin or 1,2-ethylene glycol, sugars, sugar alcohols, lactic acid, or antioxidants.

In one preferred embodiment, dishwashing detergents according to the invention contain as a further component at least one zinc salt as a glass corrosion inhibitor. The zinc salt may be an inorganic or organic zinc salt. The zinc salt to be used according to the invention preferably has a solubility in water of greater than 100 mg/L, preferably greater than 500 mg/L, particularly preferably greater than 1 g/L, and in particular greater than 5 g/L (all solubilities at 20° C. water temperature). The inorganic zinc salt is preferably selected from the group consisting of zinc bromide, zinc chloride, zinc iodide, zinc nitrate, and zinc sulfate. The organic zinc salt is preferably selected from the group consisting of zinc salts of monomeric or polymeric organic acids, in particular from the group consisting of zinc acetate, zinc acetylacetonate, zinc benzoate, zinc formate, zinc lactate, zinc gluconate, zinc ricinoleate, zinc abietate, zinc valerate, and zinc p-toluenesulfonate. In one particularly preferred embodiment according to the invention, zinc acetate is used as the zinc salt.

The zinc salt is preferably contained in cleaning agents according to the invention in a quantity of 0.01% by weight to 5% by weight, particularly preferably in a quantity of 0.05% by weight to 3% by weight, in particular in a quantity of 0.1% by weight to 2% by weight, relative to the total weight of the cleaning agent.

In addition or as an alternative to the zinc salts mentioned above, polyethylenimines, such as those available under the name Lupasol® (BASF), for example, are preferably used as glass corrosion inhibitors in a quantity of 0 to 5% by weight, in particular 0.01 to 2% by weight.

The at least one first phase of the dishwashing detergent may also contain a bleaching agent, in particular an oxygen bleaching agent, and optionally a bleach activator and/or bleach catalyst. If present, these are contained exclusively in the first phase.

As a preferred bleaching agent, dishwashing detergents according to the invention contain an oxygen bleaching agent from the group comprising sodium percarbonate, sodium perborate tetrahydrate, and sodium perborate monohydrate. Other examples of usable bleaching agents are peroxypyrophosphates, citrate perhydrates, and peracid salts or peracids that deliver H₂O₂, such as perbenzoates, peroxophthalates, diperazelaic acid, phthaloimino peracid, or diperdodecanedioc acid. In addition, bleaching agents from the group of organic bleaching agents may also be used. Typical organic bleaching agents are the diacyl peroxides such as dibenzoyl peroxide. Further typical organic bleaching agents are the peroxy acids, with the alkylperoxy acids and the arylperoxy acids named in particular as examples. Sodium percarbonate is particularly preferred due to its good bleach performance. Sodium percarbonate is a particularly preferred oxygen bleaching agent.

Compounds which under perhydrolysis conditions result in aliphatic peroxocarboxylic acids preferably having 1 to 10 C atoms, in particular 2 to 4 C atoms, and/or optionally substituted perbenzoic acid may be used as bleach activators. Substances bearing the O- and/or N-acyl groups having the stated number of C atoms and/or optionally substituted benzoyl groups are suitable. Multiply acylated alkylenediamines are preferred, and tetraacetylethylenediamine (TAED) has proven to be particularly suitable.

The bleach catalysts are bleach-enhancing transition metal salts or transition metal complexes such as Mn, Fe, Co, Ru, or Mo salt complexes or carbonyl complexes. In addition, Mn, Fe, Co, Ru, Mo, Ti, V, and Cu complexes having N-containing tripod ligands, as well as complexes of Co, Fe, Cu, and Ru with amine are usable as bleach catalysts. Complexes of manganese in oxidation states II, III, IV, or V, which preferably contain one or more macrocyclic ligands with the donor functions N, NR, PR, O, and/or S, are particularly advantageously used. Ligands having nitrogen donor functions are preferably used. It is particularly preferred to use bleach catalyst(s) in the agents according to the invention, which contain 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN), and/or 2-methyl-1,4,7-triazacyclononane (Me/TACN) as macromolecular ligands. Examples of suitable manganese complexes include [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂, and [Mn^{IV}₂(μ-O)₃(Me/Me-TACN)₂](PF₆)₂ (where OAc═OC(O)CH₃).

In general, the pH of the dishwashing detergent may be adjusted using customary pH regulators, the pH being selected depending on the desired purpose. In various embodiments, the pH is in a range of 5.5 to 11, preferably 6 to 10.5, more preferably 7 to 10.5, in particular greater than 7, most preferably in the range of 8.5 to 10.5. Acids and/or alkalis, preferably alkalis, are used as pH adjusters. Suitable acids are in particular organic acids such as acetic acid, citric acid, glycolic acid, lactic acid, succinic acid, adipic acid, malic acid, tartaric acid, and gluconic acid, or also amidosulfonic acid. However, it is also possible to use the mineral acids hydrochloric acid, sulfuric acid, and nitric acid or the mixtures thereof. Suitable bases come from the group of alkali metal and alkaline earth metal hydroxides and carbonates, in particular the alkali metal hydroxides, of which potassium hydroxide and in particular sodium hydroxide are preferred. However, volatile alkali is particularly preferred, for example in the form of ammonia and/or alkanolamines, which may contain up to 9 C atoms in the molecule. The alkanolamine is preferably selected from the group consisting of mono-, di-, triethanolamine and propanolamine and the mixtures thereof.

For setting and/or stabilizing the pH, the dishwashing detergent according to the invention may also contain one or more buffer substances (INCI: Buffering Agents), generally in quantities of 0.001 to 5% by weight. Buffer substances which at the same time are complexing agents or even chelating agents (chelators, INCI: Chelating Agents) are preferred. Particularly preferred buffer substances are citric acid or citrates, in particular sodium citrate and potassium citrate, for example trisodium citrate.2 H₂O and tripotassum citrate.H₂O.

Within the scope of the present invention, individual odorant compounds, for example the synthetic products of the ester, ether, aldehyde, ketone, alcohol, and hydrocarbon type, may be used as perfume oils or fragrances. However, it is preferred to use mixtures of various odorants which together produce a pleasant scent. Such perfume oils may also contain natural odorant mixtures available from plant sources, such as pine, citrus, jasmine, patchouli, rose, or ylang-ylang oils.

In addition, preservatives may be contained in the dishwashing detergent according to the invention. Examples of suitable preservatives are those from the group comprising alcohols, aldehydes, antimicrobial acids and/or the salts thereof, carboxylic acid esters, acid amides, phenols, phenol derivatives, diphenyls, diphenylalkanes, urea derivatives, oxygen and nitrogen acetals and formals, benzamidines, isothiazoles and the derivatives thereof such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynylbutyl carbamate, iodine, iodophores, and peroxides. Preferred antimicrobial active ingredients are preferably selected from the group comprising ethanol, n-propanol, isopropanol, 1,3-butanediol, phenoxyethanol, 1,2-propylene glycol, glycerin, undecylenic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorophenyl)-N-(3,4-dichlorophenyl) urea, N,N-(1,10-decandiyldi-1-pyridinyl-4-ylidene)-bis-(1-octanamine) dihydrochloride, N,N′-bis-(4-chlorophenyI)-3,12-diimino-2,4,11,13-tetraazatetradecane diimidamide, antimicrobial quaternary surface-active compounds, and guanidines. However, particularly preferred preservatives are selected from the group comprising salicylic acid, quaternary surfactants, in particular benzalkonium chloride and isothiazoles, and the derivatives thereof such as isothiazolines and isothiazolinones.

To facilitate the disintegration of pre-prepared shaped bodies, it is possible to incorporate disintegration agents, so-called tablet disintegrants, into these agents in order to shorten the disintegration times. Tablet disintegrants or disintegration accelerators are understood to mean auxiliaries that ensure rapid disintegration of tablets in water or other media and quick release of the active ingredients. Disintegration agents may preferably be used in quantities of 0.5 to 10% by weight, preferably 3 to 7% by weight, and in particular 4 to 6% by weight, in each case relative to the total weight of the agent containing the disintegration auxiliary.

As described above, the dishwashing detergent according to the invention comprises at least two phases, the first phase being solid and compacted, and the second phase being made of a melt core. For production of such a dishwashing detergent, first of all the first phase is produced in the form of a pressed powder phase according to methods known in the prior art. After preparation, the first phase preferably has a depression or the like into which the second phase may be introduced as a melt. For this purpose, the components of the melt phase are mixed at temperatures at which the components of the melt phase are present predominantly, preferably completely, in liquefied form, for example at temperatures above 50° C. The melting temperature of this melt depends on the melting points of the particular components used. The liquid melt is subsequently poured hot into the depression, provided for this purpose, in the first solid phase of the dishwashing detergent, so that the melt can harden. Alternatively, the hot liquid melt of the second phase may be preshaped as desired in some other mold provided for this purpose, so that it may be subsequently adhered to a suitable location, provided for this purpose, on the surface of the solid first phase. Such a suitable location on the surface of the first solid may be a suitable depression or recess, for example. The hardened melt has a more attractive appearance compared to pressed powder phases.

In various embodiments, the dishwashing detergent according to the invention includes multiple first phases, for example two first phases, which are independent of one another as defined above. Thus, for example, one of the first phases may contain bleaching agent and other ingredients, and the other may contain enzymes and other ingredients. The multiple first phases are combined into a multiphase base tablet, for example by means of the above-described methods, which then has a depression or the like into which the melt core is introduced as described above.

According to one preferred embodiment, the multiphase dishwashing detergent is tightly wrapped by a water-soluble film or is contained in a water-soluble bag.

The water-soluble film or the water-soluble bag preferably includes a water-soluble polymer. Several preferred water-soluble polymers that are preferably used as water-soluble packaging are polyvinyl alcohols, acetalized polyvinyl alcohols, polyvinylpyrrolidone, polyethylene oxides, celluloses, and gelatins, with polyvinyl alcohols and acetalized polyvinyl alcohols particularly preferably being used.

“Polyvinyl alcohols” (abbreviation: PVAL, occasionally also PVOH) is the name for polymers having the general structure

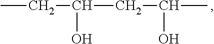

which in small proportions (approximately 2%) also contain structural units of the following type:

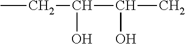

Commercially available polyvinyl alcohols, which are supplied as white-yellowish powders or granulates with degrees of polymerization in the range of approximately 100 to 2500 (molar masses of approximately 4000 to 100,000 g/mol), have degrees of hydrolysis of 87-99 mol-%, and thus also have a residual content of acetyl groups.

Within the scope of the present invention, it is preferred that the water-soluble packaging includes, at least in part, a polyvinyl alcohol having a degree of hydrolysis of preferably 70 to 100 mol-%, in particular 80 to 90 mol-%, particularly preferably 81 to 89 mol-%, and most preferably 82 to 88 mol-%. In one preferred embodiment, the water-soluble packaging is composed of at least 20% by weight, particularly preferably at least 40% by weight, very particularly preferably at least 60% by weight, and in particular at least 80% by weight of a polyvinyl alcohol having a degree of hydrolysis of 70 to 100 mol-%, preferably 80 to 90 mol-%, particularly preferably 81 to 89 mol-%, and in particular 82 to 88 mol-%.

Polyvinyl alcohols of a certain molecular weight range are preferably used as materials for the packaging, it being preferred according to the invention that the packaging material includes a polyvinyl alcohol having a molecular weight in the range of 5000 g·mol⁻¹ to 100,000 g·mol⁻¹, preferably 10,000 g·mol⁻¹ to 90,000 g·mol⁻¹, particularly preferably 12,000 g·mol⁻¹ to 80,000 g·mol⁻¹, and in particular 15,000 g·mol⁻¹ to 70,000 g·mol⁻¹.

The degree of polymerization of such preferred polyvinyl alcohols is between approximately 200 and approximately 2100, preferably between approximately 220 and approximately 1890, particularly preferably between approximately 240 and approximately 1680, and in particular between approximately 260 and approximately 1500.

The water solubility of polyvinyl alcohol may be modified by aftertreatment with aldehydes (acetalization) or ketones (ketalization). It has been found that polyvinyl alcohols that are acetalized or ketalized, respectively, with the aldehyde or keto groups of saccharides or polysaccharides or mixtures thereof are particularly preferred, and, due to their exceptionally good cold water solubility, particularly advantageous. The reaction products of polyvinyl alcohol and starch are extremely advantageous to use. In addition, the water solubility may be modified, and thus set to desired values in a targeted manner, by complexing with Ni or Cu salts or by treatment with dichromates, boric acid, or borax.

The water-soluble bag preferably has a thickness of 10 μm to 500 μm, in particular 20 μm to 400 μm, particularly preferably 30 μm to 300 μm, very preferably 40 μm to 200 μm, most preferably 50 μm to 150 μm. A polyvinyl alcohol that is particularly preferably used is available under the trade name M8630 (Monosol), for example.

The water-soluble film ((tight) wrapping) particularly preferably includes polyvinyl alcohol, as described above; as the starting thickness, preferably a thickness of 10 μm to 100 μm, in particular 12 μm to 60 μm, particularly preferably 15 μm to 50 μm, very preferably 20 μm to 40 μm, most preferably 22 μm to 35 μm, is used.

In the case of a tight wrapping, in each case a single portion of the washing or cleaning agent is wrapped. For the single portion of washing or cleaning agent wrapped according to the invention, it is important that the wrapping lies tightly against the surface of the tablets at every location. The wrapping is ideally even under tension, which, however, is not absolutely necessary. This close contact of the wrapping is conducive to the disintegration: upon initial contact with water, the wrapping will allow a small quantity of water to pass through at some location, so that initially it does not even need to dissolve. The disintegrant contained in the tablet begins to swell at this location. As a result, the wrapping now suddenly tears open due to the increase in volume of the tablet, and releases the tablet. For a wrapping that does not make close contact, the mechanism described here does not function, since the tablet is able to swell without thus bursting the wrapping. The use of a swellable disintegrant is superior to a system that evolves gas, since its bursting effect in any case results in the wrapping tearing open. In a system that evolves gas, the bursting effect may “fizzle out” due to escape of the gas from a leak in the wrapping.

Single portions of washing or cleaning agents preferred according to the invention are wherein the distance between the single portion and the water-soluble wrapping is 0.1 to 1000 μm, preferably 0.5 to 500 μm, particularly preferably 1 to 250 μm, and in particular 2.5 to 100 μm, over the entire surface area.

In one preferred embodiment, the film wrapping is initially loosely placed around a single portion of washing or cleaning agent and welded, then shrunk onto same, resulting in close contact between the film packaging and the cleaning agent concentrate. Consequently, single portions of washing or cleaning agent according to the invention are wherein the wrapping is a film packaging that is shrunk onto same.

For example, this wrapping may take place by placing a water-soluble lower film on a transport chain or a mold, then placing one or more portions of washing or cleaning agent on the lower film, and subsequently placing a water-soluble upper film on the portion(s) of washing or cleaning agent on the lower film, and fixing it to the lower film so as to enclose the portion(s) of washing or cleaning agent. Alternatively, this step may take place using a single-strand film which is then laid as a tube around the single portions. Sealing and optional cutting of the films then takes place. The film may subsequently be shrunk on using hot air or infrared radiation, optionally with pressing.

Such water-soluble wrappings have also already been described in the patent applications WO 2004/031338 A and WO 2003/099985 A; reference is hereby made in full to the disclosures thereof.

The dishwashing detergents described herein are preferably pre-prepared in dosing units. These dosing units preferably include the quantity of washing- or cleaning-active substances necessary for one cleaning operation. Preferred dosing units have a weight between 12 and 30 g, preferably between 14 and 26 g, and in particular between 15 and 22 g. The volume of the above-mentioned dosing units and their shape are particularly advantageously selected so that dosability of the pre-prepared units via the dosing chamber of a dishwasher is ensured. The volume of the dosing unit is therefore preferably between 10 and 35 mL, preferably between 12 and 30 mL.

The corresponding use of the dishwashing detergents according to the invention is likewise the subject matter of the invention. The invention further relates to a method, in particular an automatic dishwasher method, in which a washing or cleaning agent according to the invention is used in at least one step of the method. Therefore, the subject matter of the present patent application further relates to a method for cleaning dishes in a dishwasher, in which the agent according to the invention is dosed into the interior of a dishwasher during a dishwasher cycle, prior to or during the main rinse cycle. The dosing or the introduction of the agent according to the invention into the interior of the dishwasher may take place manually, although the agent is preferably dosed into the interior of the dishwasher by means of the dosing chamber.

The embodiments described in the context of the agents according to the invention are readily transferable to the methods and uses according to the invention, and vice versa.

### EXAMPLES

TABLE 1

| | | | | | Standard | | |
|---|---|---|---|---|---|---|---|
| | | | | | formula + | | |
| | | | | | surfactant/ | Standard | |
| | | | | | complexing | formula | Standard |
| | | | | | agent | + | formula + |
| | Standard formula—V1 | | | | combination—E1 | surfactant—V2 | MGDA—V3 |
| | %* | | g/job | | Addition | Addition | Addition |
| Raw material | from | to | from | to | g/job | g/job | g/job |
| Na citrate | 9.47 | 22.11 | 1.80 | 4.20 | | | |
| Citric acid | 0.53 | 5.26 | 0.10 | 1.00 | | | |
| Phosphonate | 4.21 | 7.89 | 0.80 | 1.50 | | | |
| Complexing agent | 5.26 | 18.42 | 1.00 | 3.50 | 0.75 | | 0.75 |
| (MGDA) | | | | | | | |
| Silicate | 3.68 | 7.89 | 0.70 | 1.50 | | | |
| Soda | 16.84 | 26.32 | 3.20 | 5.00 | | | |
| Na percarbonate | 13.16 | 18.42 | 2.50 | 3.50 | | | |
| Manganese bleach | 0.01 | 0.11 | 0.002 | 0.02 | | | |
| catalyst | | | | | | | |
| TAED | 2.11 | 3.16 | 0.40 | 0.60 | | | |
| C10-endcapped | 1.58 | 2.63 | 0.30 | 0.50 | 0.57 | 0.57 | |
| fatty alcohol | | | | | | | |
| ethoxylate | | | | | | | |
| C12-endcapped | 1.05 | 2.63 | 0.20 | 0.50 | | | |
| fatty alcohol | | | | | | | |
| ethoxylate | | | | | | | |
| Fatty alcohol | 0.53 | 1.05 | 0.10 | 0.20 | | | |
| ethoxypropoxylate | | | | | | | |
| Benzotriazole | 0.05 | 0.26 | 0.01 | 0.05 | | | |
| Sulfo polymer | 5.26 | 9.47 | 1.00 | 1.80 | | | |
| Cationic | 0.26 | 0.79 | 0.05 | 0.15 | | | |
| copolymer | | | | | | | |
| Polyethylene | 1.32 | 2.63 | 0.25 | 0.50 | | | |
| glycol | | | | | | | |
| Protease | 2.11 | 5.26 | 0.40 | 1.00 | | | |
| Amylase | 0.42 | 1.05 | 0.08 | 0.20 | | | |
| Fragrance | 0.05 | 0.16 | 0.01 | 0.03 | | | |
| Dyes | 0.53 | 1.32 | 0.10 | 0.25 | | | |
| Zn acetate | 0.05 | 0.53 | 0.01 | 0.10 | | | |
| Na sulfate | 0.53 | 2.63 | 0.10 | 0.50 | | | |
| Water | 0.05 | 0.53 | 0.01 | 0.10 | | | |
| | 69.06 | 140.53 | 13.12 | 26.70 | | | |

*relative to 19 g tablet weight

### Example 1: Clear Rinse Test

For determining the rinse effect, selected and defined parts of dishes were rinsed four times and visually assessed after the 2nd, 3rd, and 4th rinse cycle. The first rinse operation was used to condition the dish parts.

As parameters, clear rinse scores were assigned based on the visual appearance of the dried wash item (porcelain, glasses, plastic parts, and stainless steel).

A tablet having the formulation stated above was dosed, and 100 g soil was dosed for each rinse operation in order to simulate a normally soiled load.

The spotting was determined in two different dishwashers: a Bosch SMS 68M62 in the “50° C. Eco Vario Speed” program, and a Miele G698 SC+ in the “Normal 50° C.” program. Water hardness: 21° dH.

After completion of the rinse cycle, the machine was left completely open for 30 minutes, and the rinse effect was subsequently visually determined in a black box (black-painted chamber, D6500 daylight lamp). Dried-on water droplets, streaks, coatings, and films remaining on the dishes and utensils were assessed on a scale of 1 to 10. “10” means no films and no drops, while “1” means heavy film formation or heavy droplet formation.

The following result was obtained after adding the surfactant-complexing agent combination according to the invention:

TABLE 2

| | | Spotting | | | |
|---|---|---|---|---|---|
| | | Miele | | Bosch | |
| | | Melamine | Tupperware | Melamine | Tupperware |
| V1 | Standard | 3.9 | 3.0 | 7.0 | 3.7 |
| V2 | Standard + | 8.0 | 6.3 | 7.0 | 5.3 |
| | surfactant | | | | |
| V3 | Standard + | 4.1 | 3.5 | 6.9 | 4.0 |
| | complexing | | | | |
| | agent | | | | |
| E1 | Standard | 8.8 | 8.3 | 8.6 | 5.5 |
| | surfactant/ | | | | |
| | complexing | | | | |
| | agent | | | | |
| | combination | | | | |

It is clearly apparent that adding the combination of surfactant and complexing agent resulted in an improvement in the spotting (drop formation). The complexing agent alone had neither a positive effect nor a negative effect on the result. The surfactant showed a positive effect on the result, although to a lesser extent than when the combination of both Substances was Used.

### Example 2: Production

The production of an automatic dishwasher tablet according to formula V1, composed of two individual phases pressed one on top of the other, and a third core phase as a core that was adhesively bonded into a depression, posed no technical difficulties. In contrast, the combination of formulas V3 and E1 presented technical difficulties in the tableting.

It was necessary to find an approach that allowed use of a greater quantity of MGDA in the overall formulation. For this purpose, for a three-phase solid phase tablet an alternative to the separately pressed and adhesively bonded core had to be found. The combination was achievable by use of an enclosed melt core.

The performance requirement combined with corresponding technical manufacturability resulted in the following requirements for a formulation of the melt phase containing active ingredient:
high concentration of active substances
available as a pourable compound
rapid hardening
remeltable, recyclable

Production of a pourable compound, procedure:

The underlying concept was to produce a hardenable compound based on MGDA powder.
Suitable raw material combinations and production parameters were investigated in preliminary tests, such as the following:
suitable solvent (propylene glycol, glycerin, Biodac, etc.)
solvent distribution
auxiliaries for solidification
formulation content of MGDA powder
introduction of further active substances
required temperature profile

A resulting base formulation which satisfied many of the requirements had the following composition:

Raw material

| | |
|---|---|
| MGDA powder | 50% |
| PEG 4000 | 20% |
| Nonionic surfactant | 30% |

For production of the compound, PEG 4000 and a nonionic surfactant (Dehypon E127, already liquefied) were placed in a 20-L glass container with an anchor agitator and homogenized at 75° C. MGDA powder was then stirred into the clear melt. The hot beige-colored, freely flowing compound was castable, and solidified after standing for approximately 5 min at room temperature when shaped bodies having dimensions of 13.5 mm×22.5 mm (with h=6-7 mm, arched) were cast. The shaped bodies were solid to the touch.

The advantage of this formulation is that it may be used to produce shaped bodies that contain a high proportion of MGDA and have no problems with regard to pressability. The rapid hardening time of 5 minutes represents another technical advantage.

What is claimed is:

1. A dishwashing detergent comprising at least one first solid compacted phase and at least one second phase, wherein the at least one second phase is a melt core that includes at least one surfactant in a quantity of 1 to 90% by weight, relative to the total weight of the melt core, and at least one complexing agent from the group of aminocarboxylic acids and the salts thereof, in a quantity of 1 to 90% by weight relative to the total weight of the melt core.

2. The dishwashing detergent according to claim 1, wherein the nonionic surfactants contained in the at least one second phase are end-capped nonionic surfactants of formula R¹O[CH₂CH₂O]ₓR², where R¹ stands for linear or branched, saturated or unsaturated, aliphatic or aromatic hydrocarbon functional groups having 2 to 30 carbon atoms and R² stands for linear or branched, saturated or unsaturated, aliphatic or aromatic hydrocarbon functional groups having 1 to 30 carbon atoms, and x stands for values between 1 and 80.

3. The dishwashing detergent according to claim 2, wherein R¹ stands for a linear or branched C₁₂₋₂₀ alkyl functional group and/or R² stands for a linear or branched C₄₋₂₂ alkyl functional group.

4. The dishwashing detergent according to claim 2, wherein the at least one second phase contains, in addition to the end-capped nonionic surfactants, at least one non-endcapped, poly(oxyalkylated) nonionic surfactant of formula R¹O[CH₂CH₂O]ₓH, where R¹ stands for linear or branched, saturated or unsaturated, aliphatic or aromatic hydrocarbon functional groups having 2 to 30 carbon atoms, and x stands for values between 1 and 80.

5. The dishwashing detergent according to claim 4, wherein R¹ stands for a linear or branched C₁₂₋₂₀ alkyl functional group.

6. The dishwashing detergent according to claim 1, wherein the nonionic surfactants of the at least one second phase have a melting point above 25° C.

7. The dishwashing detergent according to claim 1, wherein the complexing agent is methylglycinediacetic acid.

8. The dishwashing detergent according to claim 1, wherein the at least one first phase contains at least one surfactant.

9. The dishwashing detergent according to claim 8, wherein the at least one first phase contains at least one further ingredient selected from the group consisting of builders, polymers, bleaching agents, bleach activators, bleach catalysts, enzymes, thickeners, sequestering agents, electrolytes, corrosion inhibitors, glass corrosion inhibitors, foam inhibitors, dyes, additives for improving the runoff and drying behavior, disintegration agents, preservatives, pH adjusters, fragrances, and fragrance carriers.

10. A method for machine-cleaning dishes comprising a step wherein dishes are contacted with a washing or cleaning agent according to claim 1.

11. The dishwashing detergent according to claim 1 comprising at least one first solid compacted phase and at least one second phase, wherein the at least one second phase is a melt core that includes a nonionic surfactant, in a quantity of 10 to 40% by weight, relative to the total weight of the melt core, and at least one complexing agent from the group of aminocarboxylic acids and the salts thereof, in a quantity of 30 to 60% by weight, relative to the total weight of the melt core.

12. The dishwashing detergent according to claim 2, wherein the nonionic surfactants contained in the at least one second phase are end-capped nonionic surfactants of formula R¹O[CH₂CH₂O]ₓR², where R¹ stands for linear or branched, saturated or unsaturated, aliphatic or aromatic hydrocarbon functional groups having 4 to 22 carbon atoms, and R² stands for linear or branched, saturated or unsaturated, aliphatic or aromatic hydrocarbon functional groups having 1 to 30 carbon atoms, and x stands for values between 15 and 50.

13. The dishwashing detergent according to claim 2, wherein the nonionic surfactants contained in the at least one second phase are end-capped nonionic surfactants of formula R¹O[CH₂CH₂O]ₓR², where R¹ stands for linear or branched, saturated or unsaturated, aliphatic or aromatic hydrocarbon functional groups having 2 to 30 carbon atoms, and R² stands for linear or branched, saturated or unsaturated, aliphatic or aromatic hydrocarbon functional groups having 1 to 30 carbon atoms, and x stands for values between 20 and 25.

14. The dishwashing detergent according to claim 3, wherein R¹ stands for a linear or branched C₁₆₋₁₈ alkyl functional group, and/or R² stands for a linear or branched C₄₋₁₄ alkyl functional group.

15. The dishwashing detergent according to claim 3, wherein R¹ stands for a linear or branched C₁₂₋₂₀ alkyl functional group, and/or R² stands for a linear or branched C₆₋₁₂ alkyl functional group.

16. The dishwashing detergent according to claim 3, wherein R¹ stands for a linear or branched C₁₂₋₂₀ alkyl functional group, and/or R² stands for a linear or branched C₈₋₁₀ alkyl functional group.

17. The dishwashing detergent according to claim 4, wherein the at least one second phase contains, in addition to the end-capped nonionic surfactants, at least one non-endcapped, poly(oxyalkylated) nonionic surfactant of formula R¹O[CH₂CH₂O]ₓH, where R¹ stands for linear or branched, saturated or unsaturated, aliphatic or aromatic hydrocarbon functional groups having 4 to 22 carbon atoms, and x stands for values between 15 and 50.

18. The dishwashing detergent according to claim 4, wherein the at least one second phase contains, in addition to the end-capped nonionic surfactants, at least one non-endcapped, poly(oxyalkylated) nonionic surfactant of formula R¹O[CH₂CH₂O]ₓH, where R¹ stands for linear or branched, saturated or unsaturated, aliphatic or aromatic hydrocarbon functional groups having 2 to 30 carbon atoms, and x stands for values between 20 and 25.

19. The dishwashing detergent according to claim 5, wherein R¹ stands for a linear or branched C₁₆₋₁₈ alkyl functional group.

20. The dishwashing detergent according to claim 6, wherein the nonionic surfactants of the at least one second phase have a melting point between 25 and 50° C.
